(19) United States
(12) Patent Application Publication
(10) Pub. No.: US 2022/0377101 A1
(43) Pub. Date: Nov. 24, 2022

(54) SYSTEM AND METHODS TO INCENTIVIZE ENGAGEMENT IN SECURITY AWARENESS TRAINING

(71) Applicant: KnowBe4, Inc., Clearwater, FL (US)

(72) Inventor: Greg Kras, Dunedin, FL (US)

(73) Assignee: KnowBe4, Inc., Clearwater, FL (US)

(21) Appl. No.: 17/745,803

(22) Filed: May 16, 2022

Related U.S. Application Data
(60) Provisional application No. 63/191,446, filed on May 21, 2021.

(51) Int. Cl. H04L 9/40

(52) U.S. Cl. CPC H04L 63/1433; H04L 63/1483

(57) ABSTRACT

Systems and methods to incentivize engagement in security awareness training are disclosed. The systems and methods include a user enrolling in a simulated self-phishing system that enables the user to receive simulated self-phishing communications and be scored on the user's interactions with the simulated self-phishing communications. The method includes identifying organizational information of the user, and communicating simulated self-phishing communications based at least on the organizational information of the user. The method includes receiving interaction data of the user with the simulated self-phishing communications. The method may generate a score of the user based at least on the interaction data.

### RELATED APPLICATIONS

This patent application claims the benefit of and priority to U.S. Provisional Patent Application No. 63/191,446 titled “SYSTEM AND METHODS TO INCENTIVIZE ENGAGEMENT IN SECURITY AWARENESS TRAINING,” and filed May 21, 2021, the contents of all of which are hereby incorporated herein by reference in its entirety for all purposes

This disclosure generally relates to security awareness training. In particular, the present disclosure relates to systems and methods to incentivize engagement in security awareness training.

### BACKGROUND OF THE DISCLOSURE

Cybersecurity incidents such as phishing attacks may cost organizations in terms of loss of confidential and/or important information, and the expense of awareness training programs in mitigating losses due to a breach of confidential information. Such incidents can also cause customers to lose trust in the organization. The incidents of cybersecurity attacks and the costs of mitigating damages caused due to the incidents are increasing every year. Organizations invest in cybersecurity tools such as antivirus, anti-ransomware, anti-phishing, and other quarantining platforms. Such cybersecurity tools may detect and intercept known cybersecurity attacks. However, social engineering attacks or new threats may not be readily detectable by such tools, and organizations rely on their employees to recognize such threats. Among the cybersecurity attacks, organizations have recognized phishing attacks a prominent threat that can cause serious breaches of data including confidential information such as intellectual property, financial information, organizational information, and other important information. Attackers who launch phishing attacks may evade an organization's security apparatuses and tools, and target its employees. To prevent or to reduce the success rate of phishing attacks on employees, organizations may conduct security awareness training programs for their employees, along with other security measures. Through the security awareness training programs, organizations actively educate their employees on how to spot and report suspected phishing attacks. These organizations may operate security awareness training programs through their in-house cyber security teams or may utilize third parties who are experts in cyber security matters to conduct such training Through security awareness training programs, organizations actively educate their employees on how to spot and report a suspected phishing attempt. To measure effectiveness of the security awareness training programs, the organizations may send out simulated phishing emails to the employees and observe employee responses to such emails. Based on the responses of the employees to the simulated phishing emails, the organizations may decide to provide additional cybersecurity awareness training.

Many times, despite conducting security awareness training programs for users, there are reports of successful cyber security attacks. There could be many reasons why these cyber security attacks were successful, including that the employees may not have fully understood or grasped information provided in the security awareness training programs. Also, often it is the case that the employees are busy with work and have personal lives and are required to attend the security awareness training programs for compliance purposes but aren't necessarily focused on the security implications.

### BRIEF SUMMARY OF THE DISCLOSURE

The disclosure generally relates to systems and methods for incentivizing engagement with security awareness training. In an example embodiment, a method includes receiving a request for a user of an organization to enroll in a simulated self-phishing system that enables the user to receive simulated self-phishing communications and be scored on the user's interactions with the simulated self-phishing communications, identifying organizational information of the user, communicating to one or more devices of the user one or more simulated self-phishing communications generated responsive to the user's enrollment in the simulated self-phishing system and based on the organizational information of the user, receiving, interaction data of the user with the one or more simulated self-phishing communications, and generating a score of the user based on the interaction data.

In some implementations, the method includes receiving a selection of the user to be in one of a single user mode or a multi-user mode of the simulated self-phishing system. The multi-user mode of the simulated self-phishing system is configured to display the score of the user with scores of other users in an enumerated list of scores.

In some implementations, the method includes receiving responsive to the selection of the user to be in the single user mode of the simulated self-phishing system, parameters to adjust content or delivery of the one or more simulated self-phishing communications. The parameters may comprise identification of one or more of the following: a range of time in which to receive the one or more simulated self-phishing communications, a number of how many simulated self-phishing communications to receive, and a time window in which a first simulated self-phishing communication is to be sent. In some implementations, the one or more parameters include identification of one or more of the following: a type of simulated self-phishing communication, a difficulty level of the simulated self-phishing communication and a mode of communication of the simulated self-phishing communication, and whether or not the user will receive a test.

In some implementations, the method includes generating one or more simulated self-phishing communications based on the selection of the user to be in one of the single user mode or the multi-user mode of the simulated self-phishing system.

In some implementations, the method includes receiving, by the server, personal information of the user comprising one or more of the following: a personal email address, a personal phone number, information from one or more social media accounts, a hometown of the user, a birthdate, a gender, any personally identifiable information, a club, an interest, or an affiliation.

In some implementations, the method includes generating, by the server, the one or more simulated self-phishing communications using the personal information of the user.

In some implementations, the method includes adjusting, responsive to receiving the personal information, the score of the user.

In some implementations, the method includes generating responsive to the interaction data, a test to communicate to the user and adjusting the score of the user responsive to receiving the results of the test.

In an example embodiment, a system includes one or more processors, coupled to memory and configured to: receive a request for a user of an organization to enroll in a simulated self-phishing system that enables the user to receive simulated self-phishing communications, identify organizational information of the user, communicate to the user one or more simulated self-phishing communications generated responsive to the user's enrollment in the simulated self-phishing system and based on the organizational information of the user, receive interaction data of the user with the one or more simulated self-phishing communications, and generate for display on a display device a score of the user based on the interaction data.

In an example embodiment, a system includes one or more processors, coupled to memory and configured to: receive a request of a user of an organization to enroll in a simulated self-phishing system that enables the user to receive simulated self-phishing communications, identify, organizational information of the user, communicate to one or more devices of the user one or more simulated self-phishing communications generated responsive to the user's enrollment in the simulated self-phishing system and based at least on the organizational information of the user, receive interaction data of the user with the one or more simulated self-phishing communications, and generate a score of the user based at least on the interaction data.

Other aspects and advantages of the disclosure will become apparent from the following detailed description, taken in conjunction with the accompanying drawings, which illustrate by way of example the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising a client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 depicts an implementation of some of the server architecture of a system configured to incentivize engagement of a user in security awareness training, according to one embodiment.

FIG. 3 illustrates a process depicting incentivizing engagement of a user in a single-user mode, according to one embodiment.

FIG. 4 illustrates a process depicting incentivizing engagement of the user in a multi-user mode, according to one embodiment.

FIG. 5 illustrates a process flow of a user in a single user mode from a user's perspective, according to one embodiment.

FIG. 6 illustrates a process flow of the user in a multi-user mode from a user's perspective, according to one embodiment.

FIG. 7 illustrates a process flow depicting incentivizing engagement of the user, according to one embodiment.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods the present disclosure relates to incentivizing user engagement in security awareness training.

A. Computing and Network Environment

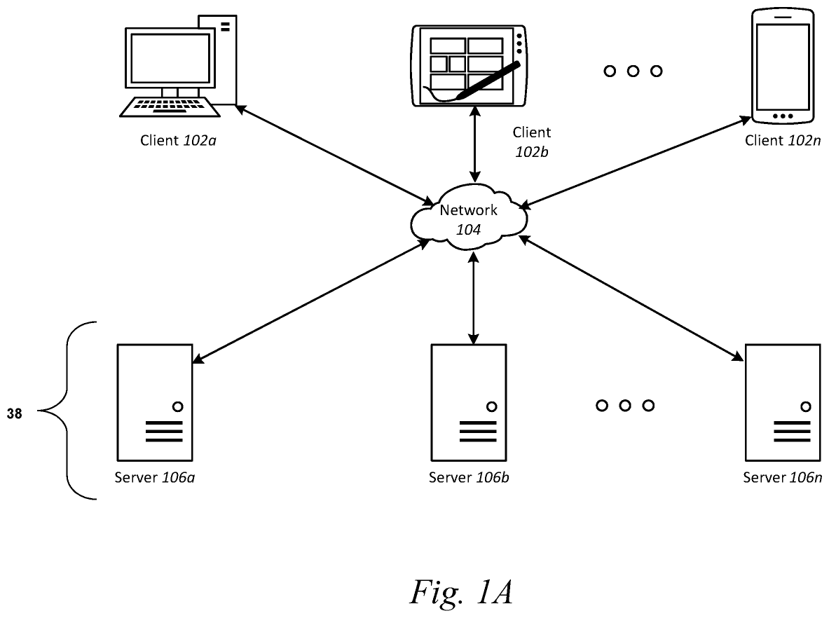

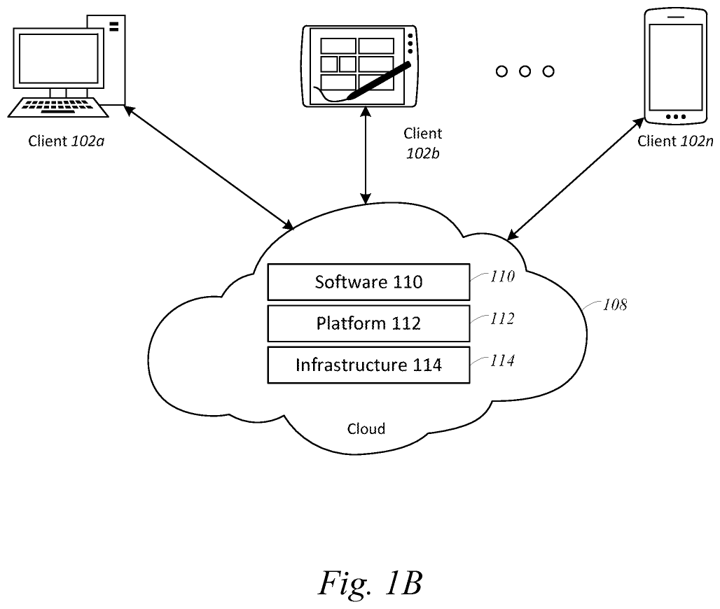

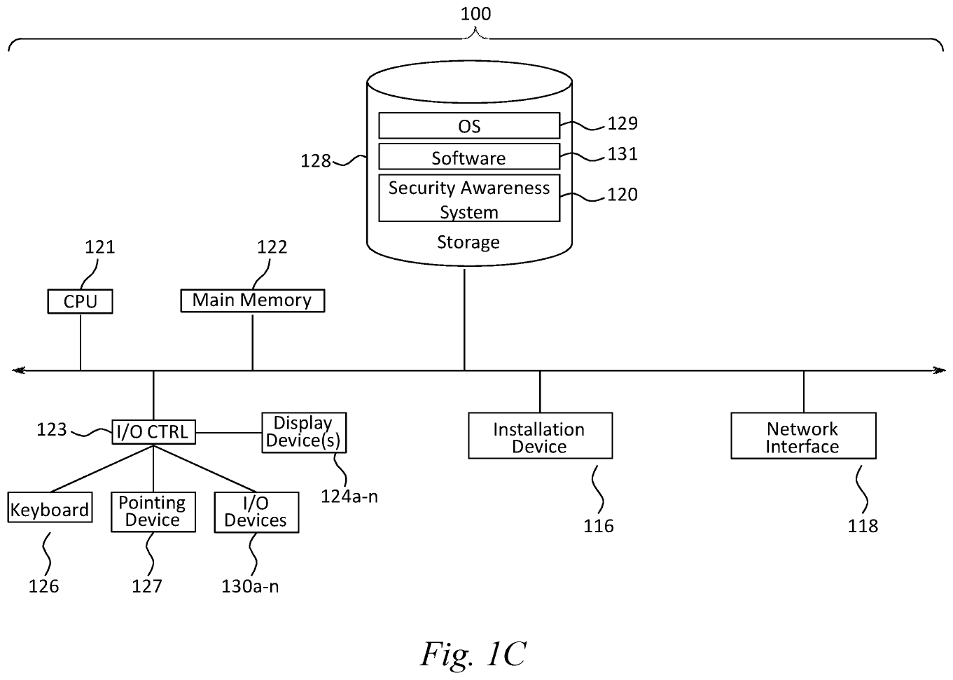

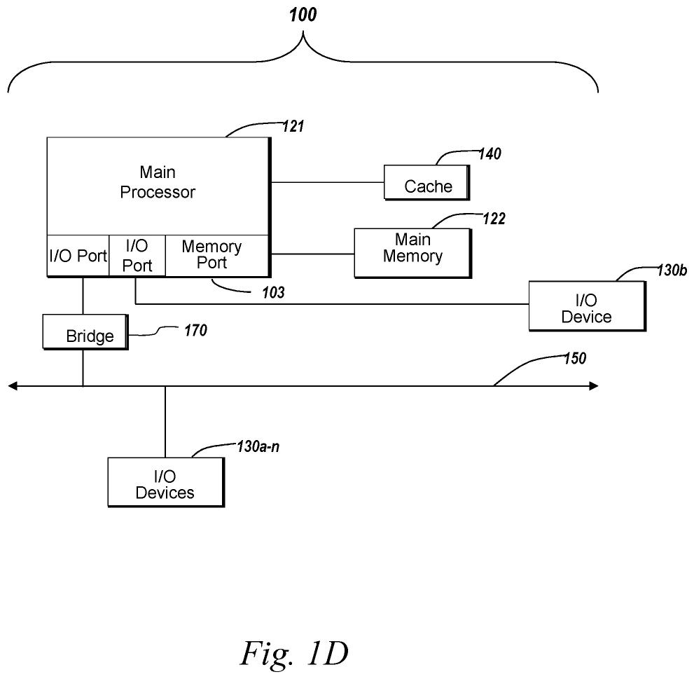

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers, or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g. Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e g Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an operating system 129, software 131, and a software of a security awareness system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include on or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts and embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts and embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g. A USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. Stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect, or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion ofthe operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, Tl, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX, and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. The IPAD line of devices by Apple; GALAXY TAB family of devices by Samsung; or KINDLE FIRE, byAmazon.com, Inc. of Seattle, Wash. In other embodiments, the computing device 100 is an eBook reader, e.g. The KINDLE family of devices by Amazon.com, or NOOK family of devices by Barnes & Noble, Inc. of New York City, N.Y.

In some embodiments, the communications device 102 includes a combination of devices, e.g. A smartphone combined with a digital audio player or portable media player. For example, one of these embodiments is a smartphone, e.g. The iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. A telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations ofthe present solution described herein. Aspects of the operating environments and components described above will become apparent in the context of the systems and methods disclosed herein.

B. Systems and Methods to Incentivize User Engagement in Security Awareness Training

The following describes systems and methods for incentivizing user engagement in security awareness training. The systems and methods provide a platform for a user to enroll and engage with a simulated self-phishing system of dynamic nature. A self-phish is a training mechanism that sends simulated phishing messages, smishing messages, wishing messages, simulated messages over any medium, messages that lend credibility, and training. A self-phish is used by a security awareness and training platform to teach security awareness within the context of a user-enrolled training program. A user enrolls to participate, and the results are incorporated into a training score. In contrast to traditional training programs that may not engage the user sufficiently, the self-phishing training system described in the disclosure enables the user to self-engage and train on-demand, leading to improved engagement and better security awareness.

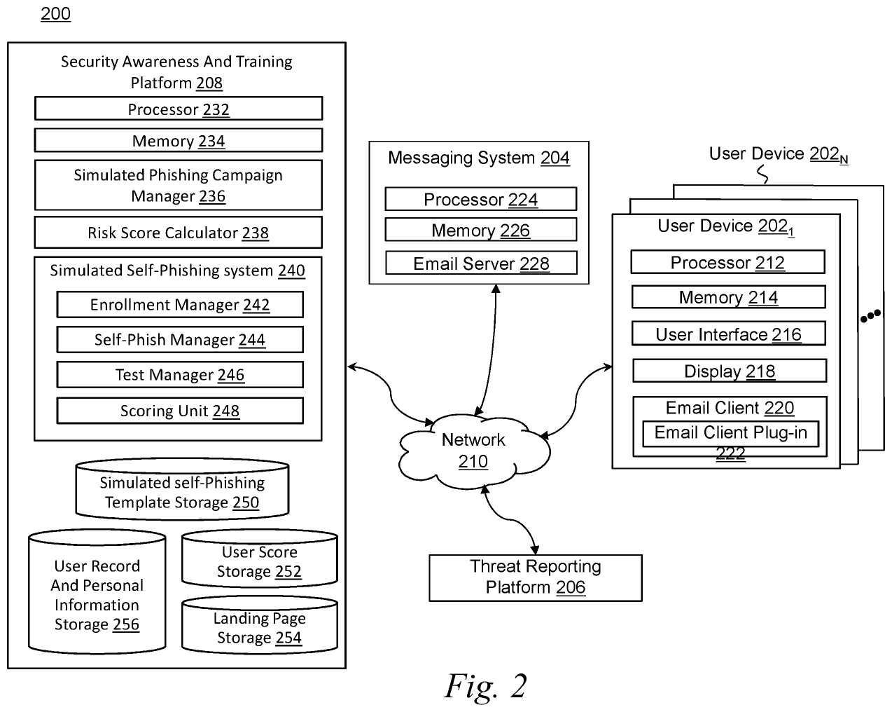

FIG. 2 depicts some of the server architecture of an implementation of system 200 for incentivizing engagement of a user in security awareness training, according to some embodiments. System 200 may be a part of security awareness system 120. System 200 may include user device(s) 202_{(1-N)}, messaging system 204, threat reporting platform 206, security awareness and training platform 208, and network 210 enabling communication between the system components for information exchange. Network 210 may be an example or instance of network 104, details of which are provided with reference to FIG. 1A and its accompanying description.

According to one or more embodiments, each of messaging system 204, threat reporting platform 206, and security awareness and training platform 208 may be implemented in a variety of computing systems, such as a mainframe computer, a server, a network server, a laptop computer, a desktop computer, a notebook, a workstation, and any other computing system. In an implementation, each of messaging system 204, threat reporting platform 206, and security awareness and training platform 208 may be implemented in a server, such as server 106 shown in FIG. 1A. In some implementations, messaging system 204, threat reporting platform 206, and security awareness and training platform 208 may be implemented by a device, such as computing device 100 shown in FIGS. 1C and 1D. In some embodiments, each of messaging system 204, threat reporting platform 206, and security awareness and training platform 208 may be implemented as a part of a cluster of servers. In some embodiments, each of messaging system 204, threat reporting platform 206, and security awareness and training platform 208 may be implemented across a plurality of servers, thereby, tasks performed by each of messaging system 204, threat reporting platform 206, and security awareness and training platform 208 may be performed by a plurality of servers. These tasks may be allocated among the cluster of servers by an application, a service, a daemon, a routine, or other executable logic for task allocation. Each of messaging system 204, threat reporting platform 206, and security awareness and training platform 208 may comprise a program, service, task, script, library, application or any type and form of executable instructions or code executable on one or more processors. Each of messaging system 204, threat reporting platform 206, and security awareness and training platform 208 may be combined into one or more modules, applications, programs, services, tasks, scripts, libraries, applications, or executable code.

Referring to FIG. 2, in some embodiments, user device 202 may be any device used by a user. The user may be an employee of an organization, a client, a vendor, a customer, a contractor, or any person associated with the organization. User device 202 may be any computing device, such as a desktop computer, a laptop, a tablet computer, a mobile device, a Personal Digital Assistant (PDA), or any other computing device. In an implementation, user device 202 may be a device, such as client device 102 shown in FIG. 1A and FIG. 1B. User device 202 may be implemented by a device, such as computing device 100 shown in FIG. 1C and FIG. 1D. According to some embodiments, user device 202 may include processor 212 and memory 214. In an example, processor 212 and memory 214 of user device 202 may be CPU 121 and main memory 122, respectively, as shown in FIGS. 1C and 1D. User device 202 may also include user interface 216, such as a keyboard, a mouse, a touch screen, a haptic sensor, a voice-based input unit, or any other appropriate user interface. It shall be appreciated that such components of user device 202 may correspond to similar components of computing device 100 in FIGS. 1C and 1D, such as keyboard 126, pointing device 127, I/O devices 130a-n and display devices 124a-n. User device 202 may also include display 218, such as a screen, a monitor connected to the device in any manner, or any other appropriate display. In an implementation, user device 202 may display received content (for example, messages) for the user using display 218 and is able to accept user interaction via user interface 216 responsive to the displayed content.

In some implementations, user device 202 may include a communications module (not shown). This may be a library, an application programming interface (API), a set of scripts, or any other code that may facilitate communications between user device 202 and any of messaging system 204, threat reporting platform 206, and security awareness and training platform 208, a third-party server, or any other server. In some embodiments, the communications module determines when to transmit information from user device 202 to external servers via network 210. In some embodiments, communications module receives information from messaging system 204, threat reporting platform 206, and/or security awareness and training platform 208, via network 104. In some embodiments, the information transmitted or received by communications module may correspond to a message, such as an email, generated or received by a messaging application.

In an implementation, user device 202 may include a messaging application (not shown). A messaging application may be any application capable of viewing, editing, and/or sending messages. For example, a messaging application may be an instance of an application that allows viewing of a desired message type, such as any web browser, a Gmail™ application (Google, Mountain View, Calif.), Microsoft Outlook™ (Microsoft, Mountain View, Calif.), WhatsApp™ (Facebook, Menlo Park, Calif.), a text messaging application, or any other appropriate application. In some embodiments, the messaging application can be configured to display electronic training In some examples, user device 202 may receive simulated phishing messages via the messaging application, display received messages for the user using display 218, and accept user interaction via user interface 216 responsive to displayed messages. In some embodiments, if the user interacts with a simulated cybersecurity attack, security awareness and training platform 208 may encrypt files on user device 202.

Referring again to FIG. 2, in some embodiments, user device 202 may include email client 220. In one example implementation, email client 220 may be an application installed on user device 202. In an example implementation, email client 220 may be an application that can be accessed over network 210 without being installed on user device 202. In an implementation, email client 220 may be any application capable of composing, sending, receiving, and reading email messages. For example, email client 220 may be an instance of an application, such as Microsoft Outlook™ application, IBM® Lotus Notes® application, Apple® Mail application, Gmail® application, or any other known or custom email application. In an example, a user of user device 202 may be mandated to download and install email client 220 by the organization. In an example, email client 220 may be provided by the organization by default. In some examples, a user of user device 202 may select, purchase and/or download email client 220 through an application distribution platform. The term “application” as used herein may refer to one or more applications, services, routines, or other executable logic or instructions.

In one or more embodiments, email client 220 may include email client plug-in 222. An email client plug-in may be an application or program that may be added to an email client for providing one or more additional features or for enabling customization to existing features. For example, email client plug-in 222 may be used by the user to report suspicious emails. In an example, email client plug-in 222 may include a user interface (UI) element such as a button to trigger an underlying function. The underlying function of client-side plug-ins that use a UI button may be triggered when a user clicks the button. Some examples of client-side plug-ins that use a UI button include, but are not limited to, a Phish Alert Button (PAB) plug-in, a Report Message add-in, a task create plug-in, a spam marking plug-in, an instant message plug-in, a social media reporting plug-in and a search and highlight plug-in. In an embodiment, email client plug-in 222 may be a PAB plug-in. In some embodiments, email client plug-in 222 may be a Report Message add-in. In an example, email client plug-in 222 may be implemented in an email menu bar of email client 220. In an example, email client plug-in 222 may be implemented in a ribbon area of email client 220. In an example, email client plug-in 222 may be implemented in any area of email client 220.

In some implementations, email client plug-in 222 may not be implemented in email client 220 but may coordinate and communicate with email client 220. In some implementations, email client plug-in 222 is an interface local to email client 220 that supports email client users. In one or more embodiments, email client plug-in 222 may be an application that supports the user, to report suspicious phishing communications that they believe may be a threat to them or their organization. Other implementations of email client plug-in 222 not discussed here are contemplated herein. In one example, email client plug-in 222 may enable the user to report any message (for example, a message that the user finds to be suspicious or believes to be malicious) through user action (for example, by clicking on the button). In some example implementations, email client plug-in 222 may be configured to analyze the reported message to determine whether the reported message is a simulated phishing message.

Referring again to FIG. 2, messaging system 204 may be an email handling system owned or managed or otherwise associated with an organization or any entity authorized thereof. In an implementation, messaging system 204 may be configured to receive, send, and/or relay outgoing emails (for example, simulated phishing communications) between message senders (for example, security awareness and training platform 208) and recipients (for example, user device 202). Messaging system 204 may include processor 224, memory 226, and email server 228. For example, processor 224 and memory 226 of messaging system 204 may be CPU 121 and main memory 122, respectively, as shown in FIG. 1C and FIG. 1D. In an implementation, email server 228 may be any server capable of handling, receiving, and delivering emails over network 210 using one or more standard email protocols, such as Post Office Protocol 3 (POP3), Internet Message Access Protocol (IMAP), Simple Message Transfer Protocol (SMTP), and Multipurpose Internet Mail Extension (MIME) Protocol. Email server 228 may be a standalone server or a part of an organization's server. Email server 228 may be implemented using, for example, Microsoft® Exchange Server, and HCL Domino®. In an implementation, email server 228 may be a server 106 shown in FIG. 1A. Email server 228 may be implemented by a device, such as computing device 100 shown in FIG. 1C and FIG. 1D. Alternatively, email server 228 may be implemented as a part of a cluster of servers. In some embodiments, email server 228 may be implemented across a plurality of servers, thereby, tasks performed by email server 228 may be performed by the plurality of servers. These tasks may be allocated among the cluster of servers by an application, a service, a daemon, a routine, or other executable logic for task allocation. In an implementation, user device 202 may receive simulated phishing communications through email server 228 of messaging system 204.

Referring back to FIG. 2, threat reporting platform 206 may be an electronic unit that enables the user to report message(s) that the user finds to be suspicious or believes to be malicious, through email client plug-in 222. In some examples, threat reporting platform 206 is configured to manage deployment of and interactions with email client plug-in 222, allowing the user to report the suspicious messages directly from email client 220. In some example implementations, threat reporting platform 206 is configured to analyze the reported message to determine whether the reported message is a simulated phishing message. In some examples, threat reporting platform 206 may analyze the reported message to determine the presence of a header, such as a simulated phishing message X-header or other such identifiers. Threat reporting platform 206 may determine that the reported message is a simulated phishing message upon identifying the simulated phishing message X-header or other identifiers.

In one or more embodiments, security awareness and training platform 208 may facilitate cybersecurity awareness training, for example, via simulated phishing campaigns, computer-based trainings, remedial trainings, and risk score generation and tracking. A simulated phishing campaign is a technique of testing a user to determine whether the user is likely to recognize a true malicious phishing attack and act appropriately upon receiving a malicious phishing attack. In an implementation, security awareness and training platform 208 may execute the simulated phishing campaign by sending out one or more simulated phishing messages periodically or occasionally to the users and observe responses of the users to such simulated phishing messages. A simulated phishing message may mimic a real phishing message and appear genuine to entice a user to respond to/interact with the simulated phishing message. Further, the simulated phishing message may include links, attachments, macros, or any other simulated phishing threat that resembles a real phishing threat. In an example, the simulated phishing message may be any message that is sent to a user with the intent of training him or her to recognize phishing attacks that would cause the user to reveal confidential information or otherwise compromise the security of the organization. In an example, a simulated phishing message may be an email, a Short Message Service (SMS) message, an Instant Messaging (IM) message, a voice message, or any other electronic method of communication or messaging. In some example implementations, security awareness and training platform 208 may be a Computer Based Security Awareness Training (CBSAT) system that performs security services such as performing simulated phishing campaigns on a user or a set of users of an organization as a part of security awareness training.

According to some embodiments, security awareness and training platform 208 may include processor 232 and memory 234. For example, processor 232 and memory 234 of security awareness and training platform 208 may be CPU 121 and main memory 122, respectively, as shown in FIGS. 1C and 1D. According to an embodiment, security awareness and training platform 208 may include simulated phishing campaign manager 236, risk score calculator 238, Simulated self-phishing system 240, self-phish manager 244, test manager 246, scoring unit 248, simulated phishing template storage 250, user score storage 252, landing page storage 254, and organizational and personal information storage 256. Simulated phishing campaign manager 236 may include various functionalities that may be associated with cybersecurity awareness training. In an implementation, simulated phishing campaign manager 236 may be an application or a program that manages various aspects of a simulated phishing attack, for example, tailoring and/or executing a simulated phishing attack. For example, simulated phishing campaign manager 236 may monitor and control timing of various aspects of a simulated phishing attack including processing requests for access to attack results, and performing other tasks related to the management of a simulated phishing attack.

In some embodiments, simulated phishing campaign manager 236 may generate simulated phishing messages. The simulated phishing message may be a defanged message, or a message that was converted from a malicious phishing message to a simulated phishing message. The messages generated by simulated phishing campaign manager 236 may be of any appropriate format. For example, the messages may be email messages, text messages, short message service (SMS) messages, instant messaging (IM) messages used by messaging applications such as, e.g., WhatsApp™, or any other type of message. Message types to be used in a particular simulated phishing communication may be determined by, for example, simulated phishing campaign manager 236. The messages may be generated in any appropriate manner, e.g., by running an instance of an application that generates the desired message type, such as a Gmail® application, a Microsoft Outlook™ application, a WhatsApp™ application, a text messaging application, or any other appropriate application. In an example, simulated phishing campaign manager 236 may generate simulated phishing communications in a format consistent with specific messaging platforms, for example Outlook365™, Outlook® Web Access (OWA), Webmail™, iOS®, Gmail®, and any other messaging platforms. The simulated phishing communications may be used in simulated phishing attacks or in simulated phishing campaigns.

Referring again to FIG. 2, in some embodiments, risk score calculator 238 may be an application or a program for determining and maintaining risk scores for users of an organization. A risk score of a user may be a representation of a vulnerability of the user to a malicious attack. In an implementation, risk score calculator 238 may maintain more than one risk score for each user. Each risk score may represent the vulnerability of the user to a specific cyberattack. In an implementation, risk score calculator 238 may calculate risk scores for a group of users, the organization, an industry, a geography, or any other set or subset of users. In an example, risk score calculator 238 may modify a risk score of a user based on the user's responses to simulated phishing communications, a user's completion of cyber security training, assessed user behavior, breach information associated with the user information, completion of training by the user, a current position of the user in the organization, a size of a network of the user, an amount of time the user has held the current position in the organization, and/or any other attribute that can be associated with the user. Risk score calculator 238 may store the risk scores and scores from the simulated self-phishing systems of the users in user score storage 252.

Simulated self-phishing system 240 may be an application or a program that provides simulated self-phishing communications and scores based on a user's interactions with the simulated self-phishing communications, to train and strengthen security awareness skills of a user without impacting a user's risk score. In an example, a simulated self-phishing communication may be an email communication with a unique simulated self-phishing communication identifier that distinguishes the simulated self-phishing communication from a malicious email, a simulated phishing email that is not part of simulated self-phishing system training programs, or an actual security threat. Simulated self-phishing system 240 may include enrollment manager 242, self-phish manager 244, test manager 246, and scoring unit 248. Enrollment manager 242 enables a user to enroll in a simulated self-phishing system. In an example, enrollment manager 242 may request enrollment information that includes basic user information such as a username, password, a user's organization email ID, or any other information in response to receiving a request from the user to enroll in the simulated self-phishing system. Enrollment manager 242 may create a user profile using the enrollment information received from the user. In some examples, the user's profile may be stored in the security awareness and training platform 208. In one embodiment, enrollment manager 242 may provide an option to the user to enroll in a single user mode and/or a multi-user mode. In some aspects, where the user chooses the single user mode, enrollment manager 242 may provide an option to the user to provide personal information and set one or more parameters to adjust content and/or delivery of the one or more simulated self-phishing communications. The personal information of the user may include one or more of a personal email address, a personal phone number, information of one or more social media accounts, hometown of the user, a birthdate, a gender, a club, interest(s), an affiliation, subscriptions, hobbies, and other personal information. In some examples, enrollment manager 242 may optionally seek access to a user's browsing history to be included as a part of personal information. The personal information of the user enables simulated self-phishing system 240 to create more complex and contextual simulated self-phishing communications. Some examples of the one or more parameters include identification of one or more of a range of time in which to receive the one or more simulated self-phishing communications, a number of how many simulated self-phishing communications to receive, a time window in which a first simulated self-phishing communication is to be sent, a type of simulated self-phishing communication, a difficulty level of the simulated self-phishing communication, and a mode of communication of the simulated self-phishing communication.

Enrollment manager 242 may receive the personal information from the user and the one or more parameters set by the user. In some examples, enrollment manager 242 may store the personal information in the user profile for use in generating one or more simulated self-phishing communications for the user, unless the user opts to not use the personal information or deletes or changes the personal information. Enrollment manager 242 encrypts and securely stores the personal information in organizational and personal information storage 256. Access to the personal information may not be provided to any human personnel. Enrollment manager 242 may store the one or more parameters set by the user in the user profile.

In the single user mode and/or in aspects where the user chooses the multi-user mode, enrollment manager 242 may identify, access and/or obtain organizational information of the user at least based on the enrollment information. The organizational information of the user includes the user's organizational email address, the user's organizational phone number, name of managers or subordinates, job title of the user, the user's geographical location, the user's start date with the organization, a work anniversary of the user, the number of years the user has been with the organization, a program or software that the user often uses, and any organizational information associated with the user. In some examples, enrollment manager 242 may store the organizational information as a part of the user profile.

Self-phish manager 244 generates one or more simulated self-phishing communications for the user based at least on information such as a user enrollment mode (the single user mode or the multi-user mode) and the user's organizational information. In examples, self-phish manager 244 generates one or more simulated self-phishing communications for the user based on a combination of personal information and organizational information. In examples, personal information and organizational information are processed using machine learning or artificial intelligence to determine which information to use, and how to use personal information and organizational information in combination to generate one or more simulated self-phishing communications. In some examples, self-phish manager 244 may use simulated phishing message templates generated by simulated phishing campaign manager 236 for generating one or more simulated self-phishing communications. In some examples, self-phish manager 244 may access simulated phishing template storage 250 and use simulated self-phishing communication templates, malicious hyperlinks, malicious attachment files, malicious macros, types of simulated cyberattacks, exploits, one or more categories of simulated phishing communications content, defanged messages or stripped messages, and any other content designed to test security awareness of users. A stripped message is a message created from a malicious message that has malicious elements stripped out of it, so that the message is benign.

In a single user mode, self-phish manager 244 may use one or more of the user's organizational information, one or more parameters set by the user and/or the personal information (if provided) to generate a contextually relevant simulated self-phishing communication. Self-phish manager 244 may analyze the organizational information, one or more parameters set by the user and/or the personal information to identify contexts that can be used in generating the simulated self-phishing communication. The context may be derived from events associated with the user, the user's activities, and/or the user's organizational information. For example, a user's work anniversary, annual review, renewal date of software or tool license and any related information may be used as contextual information. If the user has provided and consented to the use of the personal information, self-phish manager 244 may use Artificial Intelligence (AI) and/or Machine Learning (ML) techniques to analyze the profile of the user, including the user's personal information along with other organizational information to generate more contextually relevant simulated self-phishing communications.

In multi-user mode, self-phish manager 244 may use the user's organizational information to generate one or more simulated self-phishing communications for the user. In some examples, the users may not be provided an option to provide personal information or to set parameters in the multi-user mode. In examples, self-phish manager 244 may generate simulated self-phishing communications for the user based on the organizational information that self-phish manager 244 has access to. The users may not be provided an option to provide personal information or to set parameters in the multi-user mode because the multi-user mode enables comparisons amongst users through formats like leaderboards. Comparing the users on a common platform such as the leaderboards are equitable if every user has the same parameters for content and/or delivery of the simulated self-phishing communications, and the same amount of personal information accessible to self-phish manager 244. The leaderboard may be inaccurate if some of the users could adjust their parameters to a lesser difficulty or provide less personal information to make simulated self-phishing communications easier for themselves to recognize. Allowing self-phish manager 244 to enable the users to adjust their settings to a lesser difficulty or provide less personal information may also encourage the users to modify the one or more parameters causing self-phish manager 244 to generate simulated self-phishing communications that are easy to recognize in order to maximize leaderboard rewards. Allowing the users to adjust their settings in multi-user mode goes against a purpose of the simulated self-phishing communications which is to train, familiarize and strengthen security awareness skills of the users to recognize difficult simulated self-phishing communications to prepare them to better recognize real security threats.

In one or more embodiments, self-phish manager 244 may generate a simulated self-phishing communication identifier to be placed in each of the simulated self-phishing communications so that the simulated self-phishing communication may be recognized by email client 220, email client plug-in 222 and/or threat reporting platform 206, and not mistaken for a regular simulated phishing communication (i.e., one that is not part of a simulated phishing system training program) or mistaken for an actual security threat. Self-phish manager 244 may place the simulated self-phishing communication identifier in the simulated self-phishing communications. In one example, self-phish manager 244 may place the simulated self-phishing communication identifier in an X-header. In an example, self-phish manager 244 may place the simulated self-phishing communication identifier in a body or any other part of the simulated self-phishing communication. In some examples, the simulated self-phishing communication identifier may consist of an algorithmic hash or string which may be included in the header of the simulated self-phishing communication, the body of the simulated self-phishing communication or the attachment of the simulated self-phishing communication. The simulated self-phishing communication identifier may be presented as a string in an X-header such as, for example “X-PHISH-ID: 287217264”. In some examples, “ID” in the string identifies a recipient user of the simulated self-phishing communication, and the presence of this X-header indicates that the message is a simulated self-phishing communication. Self-phish manager 244 may communicate the one or more simulated self-phishing communications having the simulated self-phishing communication identifiers to one or more user devices 202_{1-N}.

In some examples, self-phish manager 244 may generate more than one simulated self-phishing communications to be part of a simulated self-phishing system. In some examples, the one or more simulated self-phishing communications generated for the training may include one or more malicious elements, or no malicious elements, and generated for one or more modes, or for the same mode. The one or more malicious elements may differ between each generated simulated self-phishing communication of the one or more generated simulated self-phishing communications. Self-phish manager 244 may generate more than one simulated self-phishing communications for the user in the single user mode or the multi-user mode, where the generated simulated self-phishing communications are sent in a predetermined order. In some examples, self-phish manager 244 may generate more than one simulated self-phishing communication where the generated simulated self-phishing communications may be sent in any order, for example, in a randomly selected order.

Test manager 246 is configured to receive interaction data of the user with the one or more simulated self-phishing communications from email client 220 and/or email client plug-in 222. The interaction data may include information indicating that the user has reported the simulated self-phishing communication or user interactions with the simulated self-phishing communication. Some examples of the user interactions may include clicking on a malicious link, downloading, or opening a malicious attachment, enabling a malicious macro from the malicious attachment, replying to the message, forwarding the message to someone other than a threat reporting email address or IT administration, no action or interaction with the simulated self-phishing communications and any other interactions.

Test manager 246 may generate one or more tests in response to receiving the interaction data In one example, test manager 246 may administer a test through email client 220 or email client plug-in 222. Test manager 246 may generate a code that enables email client plug-in 222 to generate a test based on the one or more parameters set by the user in the single user mode, or without parameters for the user in the multi-user mode. In some examples, the code enables the test to be executed within email client 220, in the event that a user reports the simulated self-phishing communication using email client plug-in 222 or interacts with the simulated self-phishing communication. In one example, test manager 246 may include code in an email header of the simulated self-phishing communications. The code may include one or more instructions for email client plug-in 222 or email client 220 to generate and administer a test. Email client plug-in 222 may extract the code and perform unique operations, including administering the tests based on the code in the email header. Test manager 246 may receive the test results in response to the test(s). Test results may include the number of malicious elements and indicators of phishing that the user has recognized or not recognized. In examples, an indicator of phishing is any indicator that the communication is not a benign communication, for example a misspelling in the communication. In examples, a malicious element is an element of a message, that when interacted with, may be dangerous to an organization. For example, a malicious element may be a URL or a link, and attachment, a macro, or any other element that may pose a cybersecurity risk to an organization when interacted with. In an example, test manager 246 calculates test results using a percentage of malicious elements and indicators of phishing that the user has recognized. In an example, test manager 246 calculates the test results as described below:

Let a represent the a^{th} malicious element with r total malicious elements, the test result may be represented by:

Test Reults=h=Σₐ₌₁^{r} malicious element a severity; (1)

where the severity of each malicious element is predetermined by the type of malicious element or indicator of phishing. For example, a misspelling may be a severity of 1, and a link may be a severity of 3. These are non-limiting examples of the types of data related to the simulated self-phishing communications and interactions with the simulated self-phishing communication that may be considered in creating the test results. In some embodiments, data collection associated with the test results is performed on an ongoing basis, and updated data and/or data sets may be used to re-train machine learning models or create new machine learning models that evolve as the data changes.

Scoring unit 248 may receive the test results and may analyze user interaction data along with the test results to create and/or modify a self-phish score. Analysis of the self-phish score may involve using the interaction data, the personal information of the user, and any other data that is given to scoring unit 248.

In an example, scoring unit 248 may calculate the self-phish score using:

GamS=h*f; (2)

Where GamS is the self-phish score; where his the test results or h=1 if there are no test results; where f=2 (or any number greater than 1) if the simulated self-phishing communication was reported and f=0.5 (or any number less than 1) if a malicious element was interacted with.

These are non-limiting examples of the types of data related to the simulated self-phishing communication and interactions with the simulated self-phishing communication that may be considered in creating the self-phish score. In some embodiments, data collection associated with self-phish scores is performed on an ongoing basis, and updated data and/or data sets may be used to re-train machine learning models or create new machine learning models that evolve as the data changes.

Scoring unit 248 may modify the self-phish score of the user based on various aspects. In a single user mode, scoring unit 248 may vary the self-phish score based on the parameters that the user sets. In an example, scoring unit 248 may increase the self-phish score when the user has set the parameters to receive simulated self-phishing communications of a complex nature or simulated self-phishing communications that are difficult to detect. In an example, scoring unit 248 may increase the self-phish score when the user has set the range of time within which they receive a simulated self-phish communication parameter to be large, In a multi-user mode, scoring unit 248 may place the user in a leaderboard and provide awards. In the leaderboard, scoring unit 248 may place the user's self-phish score in comparison with the self-phish scores of other users in the organization and display the self-phish score of the user with self-phish scores of other users in an enumerated list of self-phish scores. For example, scoring unit 248 may place the user in the top tier list when the user's self-phish score is in a top ten listing. In an example, scoring unit 248 may place the user in the bottom ten users if the user has a low self-phish score.

Scoring unit 248 may use the self-phish score to award badges, ranks, and other rewards to the user. In one example, scoring unit 248 may present a ‘Phish hunter’ badge to the user for scoring high without any mistakes. In an example, scoring unit 248 may present a ‘Bounce back’ badge to the user for scoring high despite the user not initially recognizing and reporting the simulated self-phish communication and but finding all of the malicious elements or indicators of phishing in the test. Scoring unit 248 may award collectibles to users based on the user's self-phish score or test results. For example, scoring unit 248 may award one virtual hook in a collection of virtual fishhooks to a user when they find a malicious element within a test, or score high enough. Scoring unit 248 may award these fishhooks as the user finds malicious elements.

Referring back to FIG. 2, in some embodiments, security awareness and training platform 208 may include simulated phishing template storage 250, user self-phish score storage 252, landing page storage 254 and organizational and personal information storage 256. In an implementation, simulated phishing template storage 250 may store simulated self-phishing communication templates, hyperlinks, attachment files, macros, types of simulated cyberattacks, exploits, one or more categories of simulated phishing communications content, defanged messages or stripped messages, and any other content designed to test security awareness of users.

Landing page storage 254 may store landing page templates. In an example, a landing page may be a webpage or an element of a webpage that appears in response to a user interaction such as clicking on a link or downloading an attachment) to provision training materials. Organizational and personal information storage 256 may store user information, personal information of the user, and contextual information associated with each user of an organization. In some examples, the contextual information may be derived from a user's device, device settings, or through synchronization with an Active Directory or other repository of user data. A contextual parameter for a user may include information associated with the user that may be used to make a simulated phishing communication more relevant to that user. In an example, contextual information for a user may include one or more of the following—language spoken by the user, locale of the user, temporal changes (for example, time at which the user changes their locale), job title of the user, job department of the user, religious beliefs of the user, topic of communication, subject of communication, name of manager or subordinate of the user, industry, address (for example, Zip Code and street), name or nickname of the user, subscriptions, preferences, recent browsing history, transaction history, recent communications with peers/managers/human resource partners/banking partners, regional currency and units, and any other information associated with the user.

The simulated self-phishing communication templates stored in simulated phishing template storage 250, self-phish scores and risk scores of the users stored in user score storage 252, training content in landing page storage 254, user information and the contextual information for the users stored in organizational and personal information storage 256, may be periodically or dynamically updated as required.

In an example, a user of an organization requests security awareness and training platform 208 enroll the user in a simulated self-phishing system to receive simulated self-phishing communications and be scored on the user's interactions with the simulated self-phishing communications. In one example, the user may request based on organization wide communication on security awareness programs from the organization to enroll in the simulated self-phishing system. In an example, the user may request based on the theme of the simulated self-phishing communications. In an example, the user may have been nominated by another user to join a specific training program in a simulated self-phishing system, which would require the user to enroll in the simulated self-phishing system. Security awareness and training platform 208 may receive a request of the user. On receiving the user request, enrollment manager 242 enables the user to enroll in simulated self-phishing system 240. In one example, enrollment manager 242 may provide web forms to provide enrollment information that includes user information such as a preferred username, password, years of experience, company email ID, and any other information, along with a choice to enroll in a single user mode and/or a multi-user mode. In an example, enrollment manager 242 may seek permission from the user to access user data from organizational and personal information storage 256 to autofill enrollment information. Based on the permission, enrollment manager 242 may access the user data for the enrollment information.

Enrollment manager 242 may receive the enrollment information from the user. Using the enrollment information, enrollment manager 242 may create a user profile for the user. As a part of enrollment, enrollment manager 242 provides an option for the user to enroll in a single user mode and/or a multi-user mode. Enrollment manager 242 may receive a selection of the user to be in the single user mode and/or a multi-user mode of the simulated self-phishing system. For the single user mode, enrollment manager 242 provides an option to the user to provide personal information, and to set one or more parameters to adjust content and/or delivery of the simulated self-phishing communications. Examples of the personal information may include one or more of a personal email address, a personal phone number, information of one or more social media accounts, a hometown of the user, a school, a college, or a university in which the user has attended, a birthdate, a gender, a club, interest(s), an affiliation, subscriptions, hobbies, and any other personal information. In an example, enrollment manager 242 may provide a form, quiz and/or mini-game for the user to share the personal information. In some examples, enrollment manager 242 may optionally seek access to a user's browsing history, personal email, and any other personal data to be included as a part of personal information. In one or more embodiments, enrollment manager 242 may enable the user to provide personal information at any time through the tenure of the user profile. According to the disclosure, the user may likely provide the personal information because an outcome of the simulated self-phishing system does not affect a risk score or any other metrics that may result in actions being taken against the user. Enrollment manager 242 may receive the personal information from the user, and the one or more parameters set by the user. The personal information may enable simulated self-phishing system 240 to create and send targeted simulated self-phishing communications that are complex, and hard for the user to distinguish from a malicious message, leading to better learning for the user. In some examples, simulated self-phishing system 240 may positively adjust a self-phish score of the user in response to the user providing the personal information.

The one or more parameters may allow the user to set and practice receiving desired types of simulated self-phishing communications on demand. Some examples of the one or more parameters include identification of one or more of a range of time in which to receive the one or more simulated self-phishing communications, a number of how many simulated self-phishing communications to receive, a time window in which a first simulated self-phishing communication is to be sent, a type of simulated self-phishing communication, a difficulty level of the simulated self-phishing communication, and a mode of communication of the simulated self-phishing communication. The range of time to receive the one or more simulated self-phishing communications parameter enables the user to set time range(s) in which to receive the simulated self-phishing communications. For example, the user may set 9:00 AM to 18:00 PM time slot to receive the one or more simulated self-phishing communications. In an example, the user may set 20:00 PM to 23:00 PM to receive the one or more simulated self-phishing communications. In an example, the user may choose to receive the one or more simulated self-phishing communications at any time. The parameter of how many simulated self-phishing communications to receive allows the user to set the number of simulated self-phishing communications to receive within a range of time. For example, the user may set the number of simulated self-phishing communications to receive two simulated self-phishing communications per day. The parameter of a time window in which a first simulated self-phishing communication is to be sent allows the user to set a time window in which to receive the first simulated self-phishing communication. In an example, the user may choose to receive the first simulated self-phishing communications at 10:00 AM to practice recognizing the phishing communications during the busy hours of email checking. The parameter of a type of simulated self-phishing communication allows the user to choose a type of simulated self-phishing communication to receive. Some examples of the types of simulated self-phishing communications include a simulated self-phishing communication having a malicious attachment, a simulated self-phishing communication having a malicious macro, a simulated self-phishing communication having a malicious URL, a simulated self-phishing communication having other malicious elements, a simulated self-phishing communication having indicators of phishing, and/or a combination of above. In an example, the user may choose the type of simulated self-phishing communication to receive is a simulated self-phishing communication with a malicious URL. The difficulty level of the simulated self-phishing communication parameter may enable the user to choose the difficulty level of the simulated self-phishing communication parameter. In an example, the difficulty level signifies difficulty in recognizing the simulated self-phishing communication as distinct from a benign email. In an example implementation, there may be ten (10) difficulty levels in phishing, and the user may choose to receive simulated self-phishing communication of level five (5) difficulty or a simulated self-phishing communication of medium difficulty. The mode of communication of the simulated self-phishing communication parameter enables the user to set the mode of communication to receive the simulated self-phishing communication. Some examples of modes of communication of the simulated self-phishing communication include phishing, wishing, or smishing communication or any combination of cybersecurity attacks. Further examples of modes of communication of the simulated self-phishing communication include email communication mode, an SMS mode, phone or voice mode, a text mode, a direct message mode, a web page, and any other mode of communication. Enrollment manager 242 may store the one or more parameters set by the user in the user profile.

In the single user mode and/or in multi-user mode, enrollment manager 242 may identify access and/or obtain organizational information of the user based on the enrollment information. Examples of the organizational information of the user include the user's organizational email address, user's organizational phone number, names of managers or subordinates, job title of the user, user's geographical location, user's start date with the organization, a work anniversary of the user, the number of years the user has been with the organization, a program or software that the user often uses, and any other organizational information associated with the user.

Self-phish manager 244 may generate one or more simulated self-phishing communications for the user based at least on information such as the user enrollment mode (the single user mode or the multi-user mode) and the user's organizational information. For the single user mode, self-phish manager 244 may generate one or more simulated self-phishing communications based on the organizational information, personal information ofthe user and/or one or more parameters set by the user.

Self-phish manager 244 may analyze at least the organizational information to generate contextually relevant simulated self-phishing communication(s). In the single user mode, self-phish manager 244 may use the organizational information, one or more parameters set by the user and/or the personal information to generate a contextually relevant simulated self-phishing communication. Self-phish manager 244 may analyze the organizational information, one or more parameters set by the user and/or the personal information to identify contexts that can be used in generating the contextually relevant simulated self-phishing communications. Some examples where self-phish manager 244 uses organizational information to generate a simulated self-phishing communication are provided. In one example, self-phish manager 244 may use a user's first name in the subject, body or an attachment in a simulated self-phishing communication. In an example, self-phish manager 244 may generate simulated self-phishing communications including a reference to landmarks or businesses that are associated with the user's geographical work location. Some examples where self-phish manager 244 may generate a contextually relevant simulated self-phishing communication by using organizational information is provided below. In one example, self-phish manager 244 may generate simulated self-phishing communications including a reference to a work anniversary of the user and a malicious link pretending to provide a reward. In an example, self-phish manager 244 may generate simulated self-phishing communications including a notice of an upcoming annual review based on the user's start date, and a malicious link to fill a malicious attachment named as ‘annual review form.’ In an example, self-phish manager 244 may communicate a simulated self-phishing communication having a prompt to install a new version or an update of the program or software with a malicious link to access the new version or update. Some examples where self-phish manager 244 uses personal information to generate the simulated self-phishing communication are provided. For example, the user may have provided personal information including a personal email, a personal phone number, and information that the user has a Twitter account. Self-phish manager 244 may use the aforementioned personal information to create and send a simulated self-phishing communication that includes a text message to their personal phone number containing a passcode for a password reset of their Twitter account, and/or an email to the user letting them know their Twitter account was compromised or someone attempted to reset their password. The text containing the passcode lends credibility to the validity of the simulated self-phish communication, and makes for a very personalized, complex simulated self-phish communication. In an example, the user may have provided personal information including a personal email, hometown information, name of a high school that the user had attended, their year of graduation, or a personal phone number. Self-phish manager 244 may use the aforementioned personal information to create and send a simulated self-phishing communication containing an invitation to a high school reunion at the high school in the user's hometown. In an example, the user may have indicated a hobby of boating. Self-phish manager 244 may use the hobby information to generate a simulated self-phishing communication containing an invitation and an attachment that purports to contain complimentary passes to the local boat show. In one or more embodiments, self-phish manager 244 may also use combination of the user's organizational information, one or more parameters set by the user and/or the personal information (if provided) to generate a more contextually relevant simulated self-phishing communication. For example, self-phish manager 244 may use the personal information such as the user's phone number, a user chosen time window for receiving a first simulated self-phishing communication which is 10:00 AM-11:00 AM, a user chosen difficulty phishing level of 6, and organizational information such as database software the user is using, to create a contextually relevant simulated self-phishing communication. In the example, self-phish manager 244 may send a simulated self-phishing communication at 10:15 AM, indicating that a customer care personnel for the database software was trying to reach the user for a database issue without success, and thus has left a voice message that is accessible through a link (malicious link) provided in the simulated self-phishing communication.

In some examples, self-phish manager 244 may generate the simulated self-phishing communications by applying organizational or user-provided personal information obtained from the organizational information. For example, self-phish manager 244 may generate a simulated self-phishing communication with a color scheme and logo of the organization of the user. In some examples, self-phish manager 244 generates simulated self-phishing communications incorporating color schemes or logos of a program or software that a user had provided as a part of their personal information. Self-phish manager 244 may derive other contexts not disclosed for simulated self-phishing communication based on the organizational information and/or the personal information (if provided) of the user. In examples, this information is derived using machine learning or artificial intelligence. Other examples not disclosed herein are contemplated. In multi-user mode, self-phish manager 244 may use the user's organizational information to generate one or more simulated self-phishing communications for the user.

Self-phish manager 244 may include one or more malicious elements in the one or more simulated self-phishing communications and one or more simulated self-phishing indicators. Self-phish manager 244 inserts the one or more simulated self-phishing communication identifiers into the one or more simulated self-phishing communications. Self-phish manager 244 may communicate the one or more simulated self-phishing communications to one or more user devices 202_{1-N}.

The user may receive the one or more simulated self-phishing communications at the one or more user devices 202_{1-N}. In one example, the user may interact with the one or more simulated self-phishing communications. The user may interact with the simulated self-phishing communication when the user does not recognize the communication as suspect or identify the simulated self-phishing communication to be a malicious message. One example of an interaction with the simulated self-phishing communication may include interacting with a malicious element of the one or more malicious elements included in the one or more simulated self-phishing communications.

In an example, the user may report the simulated self-phishing communication. The user may report the simulated self-phishing communication when the user suspects the simulated self-phishing communication to be a malicious message. In an example, the user may report the simulated self-phishing communication through email client plug-in 222 or by forwarding the simulated self-phishing communication to a threat reporting email address or an IT administrator. For example, the user may report the simulated self-phishing communication by using an email client plug-in 222 such as the Phishing Alert Button (PAB).

In an example, responsive to the user reporting the simulated self-phishing communication or interacting with the simulated self-phishing communication, email client 220 and/or email client plug-in 222 may determine that the simulated self-phishing communication is a part of the simulated self-phishing system by identifying the simulated self-phishing communication identifier (for example, in the message header, in the message body, or in a message attachment), and determine and capture the interaction of the user with the simulated self-phishing communication. In some examples, in response to the user reporting the simulated self-phishing communication or interacting with the simulated self-phishing communication, email client 220 and/or email client plug-in 222 may direct the user to a landing page, and email client 220 and/or email client plug-in 222 may note an interaction of the user with the landing page. Email client 220 and/or email client plug-in 222 may communicate the interaction data to simulated self-phishing system 240.

In some examples, the user may not interact with the simulated self-phish communication within a certain amount of time. In such a scenario, self-phish manager 244 determines next steps based on the user mode. In one example, self-phish manager 244 may resend the simulated self-phish communication to the user. In an example, self-phish manager 244 may send a reminder to the user that the simulated self-phish communication has been sent to encourage the user to try and find the simulated self-phishing communication. If reminders are sent to the user, self-phish manager 244 may reduce the self-phish score of the user. In some examples, self-phish manager 244 provides a hint to the user to help locate the simulated self-phish communication. In one example, self-phish manager 244 may identify that a user has opened emails in their mailbox after delivery of the simulated self-phish communication, and determines to resend the simulated self-phishing communication or send a reminder to the user. In an example, if self-phish manager 244 identifies that there are no new emails in a user's mailbox have been opened, then self-phish manager 244 determines the simulated self-phishing communication to be “void” and does not impact the self-phish score. In some examples, self-phish manager 244 may be configured to provide any self-phish score or provide a negative self-phish score to the user if the user does not interact with the simulated self-phishing communication within a certain threshold of time or after one or more reminders.

In response to receiving the interaction data, test manager 246 may administer one or more tests. In one example, test manager 246 may administer a test through email client 220 or email client plug-in 222. In an example, test manager 246 may administer the test through user device 202_{1-N}. In one example implementation, test manager 246 may generate a code that enables email client plug-in 222 to generate the test based on the one or more parameters set by the user in the single user mode or without parameters for the user in the multi-user mode. For example, the code may include instructions for email client plug-in 222 to deliver a notification to the user in email client 220 when the user reports the simulated self-phishing communication. The notification may display ‘Congratulations for spotting the self-phish! Can you spot the other malicious elements?’. The code may trigger email client plug-in 222 to reference test manager 246 on how to direct the user when they click additional malicious elements. Email client plug-in 222 may connect with test manager 246 in instances where the code requires email client plug-in 222 to get further data, or give specific instructions to email client 220. For example, with the additional instructions from test manager 246, email client plug-in 222 may not direct the user to a landing page for clicking on the additional malicious elements, but may send data involving the interaction along with test results to test manager 246. Email client plug-in 222 may execute additional instructions when test manager 246 has determined that the user has interacted with all of the malicious elements in the test, or a certain number or percentage of malicious elements. In some examples, email client plug-in 222 executes instructions to create notifications that explain phishing indicators to the user or to congratulate the user on finding malicious elements in the test. In some examples, test manager 246 may provide a test directly on the user device. In examples, test manager 246 may provide a test on a landing page.

In some examples, if the user clicks on a malicious element in the simulated self-phishing communication or reports the simulated self-phish communication, the code may include one or more instructions for email client plug-in 222 or email client 220 to traverse the user to a landing page which notifies the user that they have failed the simulated self-phishing system. In some examples, the landing page may also administer one or more tests with the simulated self-phishing communication that was sent to the user, track the number of malicious elements that the user is able to recognize, and deliver notifications to the user such as ‘Congratulations for finding all of the malicious elements!’. In some examples, the code may include one or more instructions for email client plug-in 222 or email client 220 to not administer the test if the user fails the simulated self-phishing communication, and the landing page may simply train the user in recognizing the malicious elements and indicators of phishing. Email client plug-in 222 executes instructions that send results of the test to test manager 246. The test is intended to reinforce learning that a simulated self-phishing communication is designed to impart. In some examples, the test may be a copy of the simulated self-phishing communication that the user has already been sent, which may, for example, be presented as a pop-up or on a landing page. In other examples, the test is always provided to the user, whether they interact with the simulated self-phishing communication or correctly identify/report the simulated self-phishing communication. In some implementations, the user may be provided a different test if they report the simulated self-phishing communication than if they interact with the simulated self-phishing communication. In response to the user scoring well, the user may be auto-promoted to a next difficulty level. Otherwise, the user may repeat the same level.

User device 202_{1-N} or email client 220 or email client plug-in 222 may communicate the test results of the test and interaction data associated with the tests to test manager 246. Test manager 246 may use the interaction data and the test results to generate a self-phish score of the user. In some examples, scoring unit 248 may adjust the self-phish score of the user in response to receiving personal information. In some examples, scoring unit 248 may award and present badges to the user based on their self-phish score. Scoring unit 248 may display the self-phish score on the display unit of user device 202_{1-N} and provide awards to the user. Enrollment manager 242 may encourage the user to nominate another user to enroll in the simulated self-phishing system. The user may nominate another user to enroll into the training programs. Enrollment manager 242 may communicate a nomination chosen by the user to another user.

Referring back to FIG. 2, simulated self-phishing system 240 may take divergent steps based on the user being in single user mode or multi-user mode. Enrollment manager 242 may invite the user to enroll in a multi-user mode if the user has been in a single user mode in the simulated self-phishing system. Enrollment manager 242 may send the user a message that enables the user to enroll in multi-user mode and train in the multi-user mode. The multi-user mode increases the user engagement by encouraging user interaction with other users. The user may start over with a training program in the multi-user mode, or the user's self-phish score may be modified by participating in another training program in multi-user mode. In some examples, simulated self-phishing system 240 may maintain a single user mode self-phish score and a multi-user mode self-phish score. In some examples, the user may be invited to join a multi-user mode if the user's single mode self-phish score exceeds a threshold.

If the user has been in the multi-user mode for the simulated self-phishing system, enrollment manager 242 may invite the user to nominate another to enroll to the simulated self-phishing system. In some examples, the user may choose a specific training program in the simulated self-phishing system that they are inviting the nominated user to join. In examples, a training program is a set of simulated self-phishing communications sent to one or more users that may result in the creation or change of a self-phish score. In some examples, the nominated user may be presented with a selection of training programs in the simulated self-phishing system that he/she is eligible to join. In examples, if the nominated user is already enrolled in the simulated self-phishing communication training program (for example, a user chose a program that the nominated user is already part of), then enrollment manager 242 may not send an invitation to the nominated user or may only send an invitation to the nominated user to join one of the training programs that the nominated user is not already a part of In some examples, if the nominated user is in a single user mode, the nominated user may be invited to join an ongoing training program in the multi-user mode. Enrollment manager 242 may make this determination by comparing the email address entered for the nominated user to a database of email addresses of users enrolled in simulated self-phishing system 240 and determining if there is a match within the whole database or within a certain program. If the nominated user is not already enrolled in the simulated self-phishing system, enrollment manager 242 may send an invitation to the nominated user to enroll in the training program. In examples, multiple multi-user mode training programs may occur concurrently. Multiple multi-user mode training programs increase user engagement by offering a variety of group training opportunities, further encouraging user interaction with other users.

If the nominated user chooses to enroll in a single player mode, the nominated user starts their own simulated self-phishing training program, optionally provides personal information and sets parameters, and receives a self-phish. If the nominated user chooses to enroll in multiplayer mode that they are eligible to participate in, the security awareness and training platform 208 adds the nominated user to the one or more chosen multiplayer training programs.

In some examples, the user may start a new multi-user training program, i.e., be the first person in the multi-user training program. The newly started multi-user training program may have an open invite to other users to join in. In some examples, there is a limited “enrollment” period for a newly established training program in simulated self-phishing system 240, or a limited number of users who may be enrolled. In an example, a user starts a multi-user game called “phishing mail-storm”. The system puts a pop up or other notification out to all users in the organization that the phishing mail-storm training is open for enrollment until (time, date), or for the first X number of users that join. Then any users which enroll before the cut off condition is met are allowed to join the training program. The enrollment can close after that date. This concept can also be used for nominated users, i.e., that they are not actually allowed to join ongoing “closed” programs but can join any game that is open for enrollment. The organization may be able to start multi-user training programs, which may present/offer enrollment as described above.

Team training programs may also be possible with simulated self-phishing training system 240. A team comprises a number of users in the same simulated self-phishing training program that are combined together for the purpose of calculating a self-phish score. In some examples, a team self-phish score is calculated based on a function of the simulated self-phishing training program scores of all the members in the team. This would look like a multi-user simulated self-phishing training program in terms of set up. In some examples, the simulated self-phishing training program score of a team is the highest self-phish score of any participant in the team. Teams may also be enabled to play against each other in a team vs. team simulated self-phishing training programs, for example accounting vs. production teams, where the team self-phish scores are arranged on a leaderboard. The high self-phish scorers of each team could be additionally ranked on a leaderboard. That is, within team play there may be a team competition as well as an individual competition.

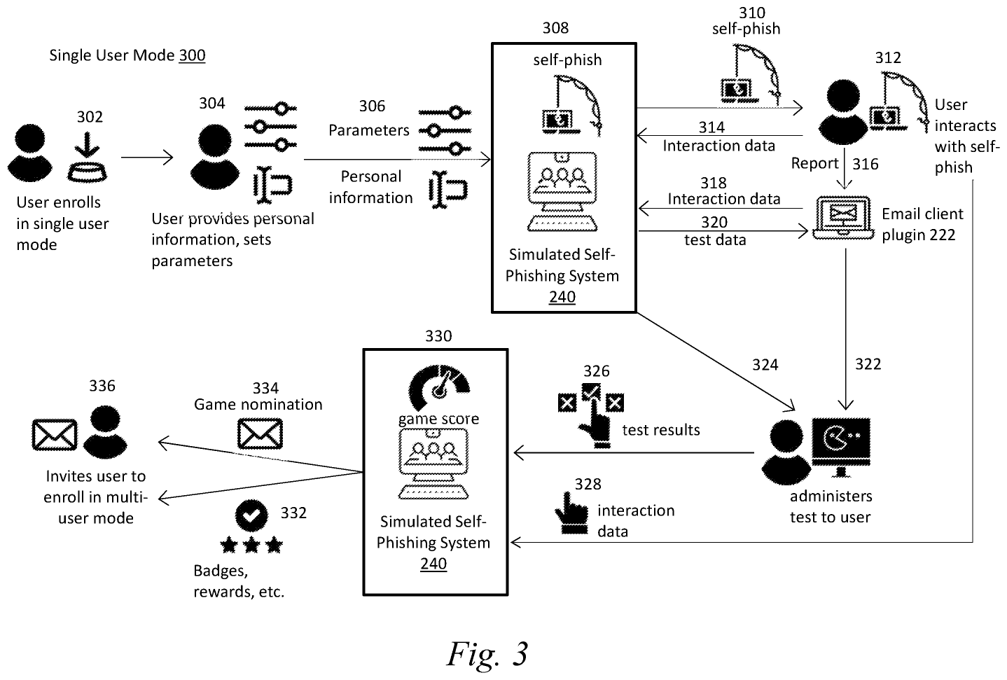

FIG. 3 illustrates a process depicting incentivizing engagement of a user in single-user mode 300, according to one embodiment.

A user of an organization makes a request to security awareness and training platform 208 to enroll in a simulated self-phishing system. As a part of enrollment, enrollment manager 242 enables the user to enroll in a single user mode and/or a multi-user mode. In example of FIG. 3, in step 302, the user enrolls in the single user mode. In response to the user enrolling in the single user mode, enrollment manager 242 in step 304, provides an option to the user to provide personal information, and to set one or more parameters to adjust content and/or delivery of the simulated self-phishing communications. The personal information of the user enables simulated self-phishing system 240 to create more complex and contextual simulated self-phishing communications. In step 306, the user may respond by providing personal information, and setting the one or more parameters. In step 308, self-phish manager 244 may generate one or more simulated self-phishing communications based on the organizational information, personal information of the user and/or one or more parameters set by the user. The one or more simulated self-phishing communications may include one or more malicious elements and one or more indicators of phishing. Self-phish manager 244 inserts the simulated self-phishing communication identifier into the one or more simulated self-phishing communications. In step 310, self-phish manager 244 may communicate the one or more simulated self-phishing communications to one or more user devices 202_{1-N}. The user may receive the one or more simulated self-phishing communications at the one or more user devices 202_{1-N}. In step 312, the user may interact with the one or more simulated self-phishing communications. The user may interact with the simulated self-phishing communication when the user does not recognize the communication as suspect or identify the simulated self-phishing communication to be a malicious message. In one example, the interaction according to step 312 may be the user interacting with the simulated self-phishing communication that may include interacting with a malicious element of the one or more malicious elements included in the one or more simulated self-phishing communications. Email client 220 or email client plug-in 222 may identify the simulated self-phishing communication based on a simulated self-phishing communication identifier. Email client 220 or email client plug-in 222 may generate interaction data by capturing user interactions with the simulated self-phishing communication. Email client 220 or email client plug-in 222 may communicate the interaction data to self-phish manager in step 314.

In step 316, the user may report the simulated self-phishing communication. In an example, the user may report the simulated self-phishing communication by using email client plug-in 222. The user may perform step 316 when the user suspects the simulated self-phishing communication to be a malicious message. In an example, the user may report the simulated self-phishing communication through email client plug-in 222 or by forwarding the simulated self-phishing communication to a threat reporting email address or IT administrator. In step 318, email client plug-in 222 may communicate the interaction data indicating that the user has reported the simulated self-phishing communication to simulated self-phishing system 240. In step 320, test manager 246 may communicate a test to email client 220. In step 322, email client plug-in 222 executes a test in email client 220 or email client plug-in 222 to administer the test to the user. In examples, in step 324 test manager 246 may generate and communicate a test to the user device to administer the test directly to the user through a landing page or an application on user device 202, in response to the user interaction. In step 326, the user device or email client 220 or email client plug-in 222 may communicate the results of the test to simulated self-phishing system 240. In step 328, the user device or email client 220 or email client plug-in 222 may communicate the interaction data to simulated self-phishing system 240. In step 330, test manager 246 may use the interaction data and the results of the test, to generate a self-phish score of the user. In some examples, scoring unit 248 may adjust the self-phish score of the user in response to receiving personal information. In step 332, scoring unit 248 may award and present badges to the user based on the self-phish score. Scoring unit 248 may display the self-phish score and awards to the user. In step 334, the user may nominate another user to enroll in the training programs. In step 336, simulated self-phishing system 240 may communicate a nomination sent by the user to another user.

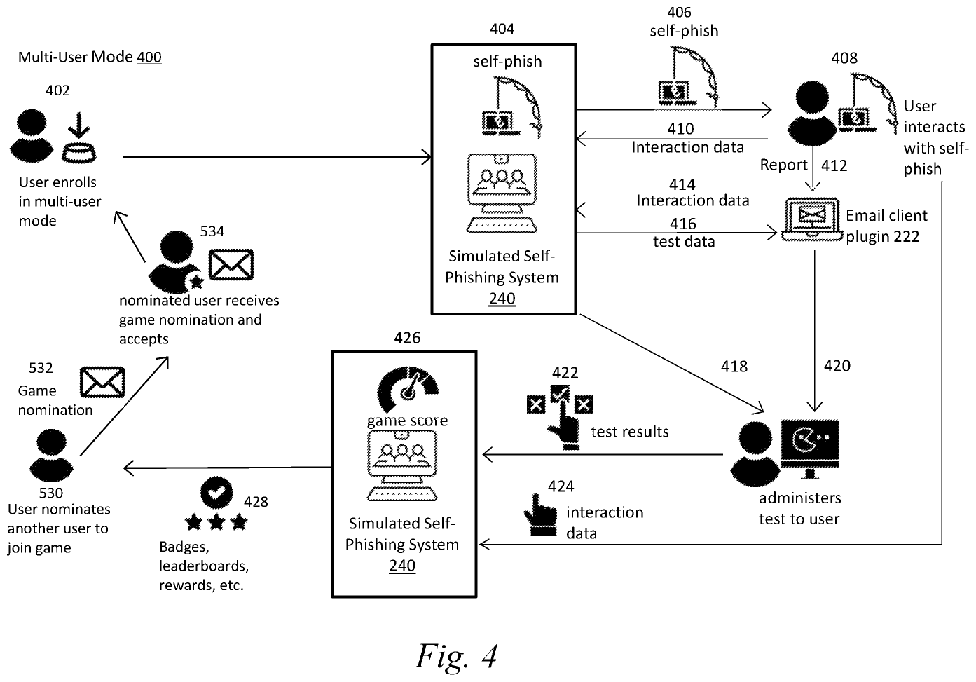

FIG. 4 illustrates a process depicting incentivizing engagement of the user in multi-user mode 400, according to one embodiment.

A user of an organization makes a request to security awareness and training platform 208 to enroll in simulated self-phishing system 240. In an example, the user may request security awareness and training platform 208 in response to a nomination of the user from a different user. In an example, the user may request security awareness and training platform 208 based on user's own interest. In response to the user request, enrollment manager 242 may check if the user is already enrolled. If the user is enrolled, enrollment manager 242 may check if the user wants to enroll in a different user mode or in a different training program. In FIG. 4, in step 402, the user enrolls in the multi-user mode. In step 404, in response to the user enrolling in the multi-user mode via enrollment manager 242, self-phish manager 244 may generate one or more simulated self-phishing communications responsive to the user's enrollment in simulated self-phishing system 240 and based on organizational information of the user. The one or more simulated self-phishing communications may include one or more malicious elements and one or more indicators of phishing. In step 406, self-phish manager 244 may communicate to one or more devices of the user, one or more simulated self-phishing communications. The user may receive the one or more simulated self-phishing communications at the one or more devices of the user. In step 408, the user may interact with the one or more simulated self-phishing communications. The interaction according to step 408 may be an interaction with the simulated self-phishing communication including interacting with a malicious element of the one or more malicious elements included in the one or more simulated self-phishing communications. Email client 220 or email client plug-in 222 may be configured to identify a simulated self-phishing communication, for example, by identifying a simulated self-phishing communication identifier in the message that indicates the message is a simulated self-phishing communication, and may communicate the interaction data including the user interactions with the simulated self-phishing communication to simulated self-phishing system 240 in step 410.

In step 412, the user may report the simulated self-phishing communication. The step 412 may be an alternative to step 408. In an example, the user may report the simulated self-phishing communication through email client plug-in 222 or forwarding the simulated self-phishing communication to a threat reporting email address or IT administration. In step 414, email client plug-in 222 may communicate the interaction data indicating that the user has reported the simulated self-phishing communication to simulated self-phishing system 240. In step 416, test manager 246 may communicate a test to email client 220 or email client plug-in 222 to administer the test to the user. In some examples, in step 418 test manager 246 may generate and communicate a test to the user device to administer the test directly to the user through the user device through a landing page. In step 420, email client plug-in 222 executes a test in email client 220 or email client plug-in 222 to administer the test to the user. In step 422, the user may respond to the test by providing responses. In step 422, the user device or email client 220 or email client plug-in 222 may communicate the results of the test to simulated self-phishing system 240. In step 424, the user device or email client 220 or email client plug-in 222 may communicate interaction data to simulated self-phishing system 240. In step 426, test manager 246 may use the interaction data and test results, to generate a self-phish score of the user. In step 428, scoring unit 248 may generate an award, determine a position in a leaderboard in comparison with other users, or present badges to the user based on the self-phish score. Scoring unit 248 may display the self-phish score and awards to the user on the dashboard. In step 430, the user may nominate another user to enroll into the simulated self-phishing systems. In step 432, simulated self-phishing system 240 may communicate a nomination sent by a user to another user. In step 434, the another user may receive and accept the nomination. The another user may enroll into the training program and the process continues from step 402.

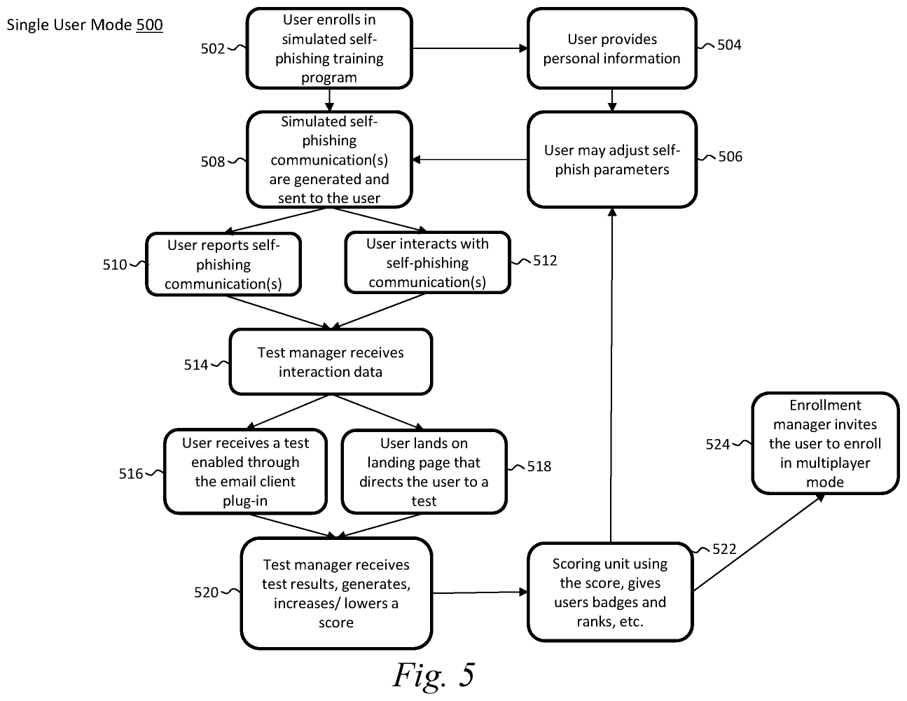

FIG. 5 illustrates a process flow depicting incentivizing engagement of a user in a single user mode from a user's perspective, according to one embodiment.

In step 502, a user enrolls in simulated self-phishing system 240. In an example, the user enrolls into simulated self-phishing system 240 through an enrollment option provided by enrollment manager 242. In one embodiment, the user enrolls in a single user mode. In step 504, the user may optionally provide personal information when the user selects to be in the single user mode. In step 506, the user may set one or more parameters to adjust one of content or delivery of the one or more simulated self-phishing communications. In step 508, one or more simulated self-phishing communications are generated and communicated to the user. The user may receive the one or more simulated self-phishing communications.

In step 510, the user reports the one or more simulated self-phishing communications as suspected malicious communications. Step 510 may occur when the user suspects that the one or more simulated self-phishing communications is a malicious communication. In an example, the user may report the one or more simulated self-phishing communications as a suspected malicious message through email client plug-in 222.

In some examples, such as in step 512, the user may interact with the one or more self-phishing communications. Step 512 may occur when the user fails to recognize the one or more simulated self-phishing communications as suspicious communications and interacts with the one or more self-phishing communications. The user may fail to recognize the one or more simulated self-phishing communications as suspicious communications due to lack of security awareness or due to the complexity of the one or more simulated self-phishing communications. In step 514, test manager 246 receives interaction data. The interaction data may include a report of the one or more simulated self-phishing communications as suspected malicious communication, or user interactions with the one or more simulated self-phishing communications.

In response to the interaction, in step 516, the user receives a test administered through email client plug-in 222. In response to the user interacting with the one or more simulated self-phishing communications, in step 518, the user lands on a landing page that directs them to a test, that is enabled through email client plug-in 222 or security awareness and training program 208.

In step 520, test manager 246 receives test results, and based on the performance of the user, test manager 246 generates a self-phish score. Using the self-phish score, test manager 246 may increase or decrease the self-phish score of the user. In step 522, scoring unit 248 may use the self-phish score to provide the user a reward, such as a badge, ranks, and any other rewards.

The user may further adjust the one or more parameters to move to step 506 to adjust content or delivery of the one or more simulated self-phishing communications. The user may continue in the training program based on adjusted one or more parameters. In step 524, enrollment manager 242 may invite the user to enroll in a multi-user mode.

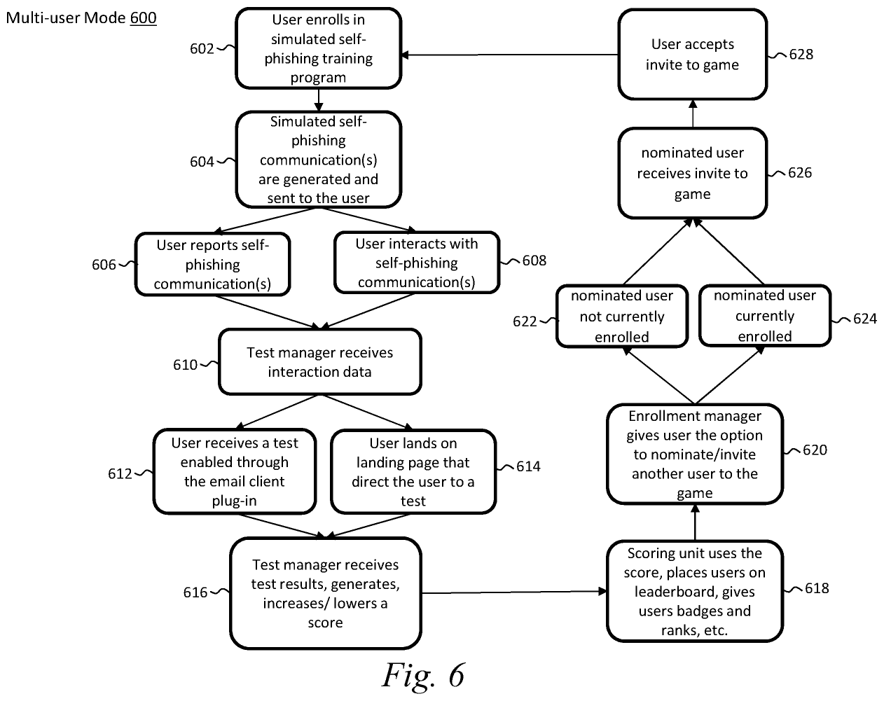

FIG. 6 illustrates a process flow depicting incentivizing engagement of a user in a single user mode from a user's perspective, according to one embodiment.

In step 602, a user enrolls in simulated self-phishing system 240. In an example, the user enrolls into simulated self-phishing system 240 through an enrollment option provided by enrollment manager 242. In an example, the user enrolls in a multi-user mode.

In step 604, self-phish manager 244 generates and communicates one or more simulated self-phishing communications to the user devices. The one or more simulated self-phishing communications generated based on the organizational information. The user may receive the one or more simulated self-phishing communications.

In step 606, the user reports the one or more simulated self-phishing communications as suspected malicious messages. Step 606 may occur when the user is able to recognize that the one or more simulated self-phishing communications are suspicious communications. In an example, the user may report the one or more simulated self-phishing communications as suspected malicious message through email client plug-in 222.

In some examples, such as in step 608, the user may interact with the one or more self-phishing communications. Step 608 may occur when the user fails to recognize the one or more simulated self-phishing communications as suspicious communications and interacts with the one or more self-phishing communications. The user may fail to recognize the one or more simulated self-phishing communications as suspicious communications due to lack of security awareness or due to complexity of the one or more simulated self-phishing communications.

In step 610, test manager 246 receives interaction data. The interaction data may include a report of user interactions with the one or more simulated self-phishing communications.

In response to the user reporting the one or more simulated self-phishing communications as a suspected malicious message, in step 612, test manager 246 may send a test to the user, that is enabled through email client plug-in 222.

In response to the user interacting with the one or more simulated self-phishing communications, in step 614, the user may land on landing page that directs them to a test, that is enabled through security awareness and training program 208.

In step 616, test manager 246 receives test results, and based on performance of the user, test manager 246 generates a self-phish score. Using the self-phish score, scoring unit 248 may increase or decrease the self-phish score of the user.

In step 618, scoring unit 248 uses the self-phish score to place the user on a leaderboard.

In some examples, scoring unit 248 may also provide the user rewards such as badges and ranks, and such rewards.

In step 620, enrollment manager 242 provides an option to the user to nominate/invite another user to enroll in simulated self-phishing system 240 and to receive one or more simulated self-phishing communications to strengthen their security awareness skills. The user may use the option to invite the other user to join a self-phishing training program.

In step 622, simulated self-phishing system 240 may determine that the nominated user is not currently enrolled. In such an instance, enrollment manager 242 may send an enrollment invitation to the nominated user to join the self-phishing training program. Otherwise, in step 624, simulated self-phishing system 240 may determine that the nominated user is currently enrolled and refrain from sending an invitation to the nominated user.

In step 626, the nominated user receives an invite to enroll to join a self-phishing training program and to receive one or more simulated self-phishing communications.

In step 628, the nominated user accepts the invitation to join the self-phishing training program. The process for the nominated user repeats from step 502 in response to the user choosing a single user mode, or process for the nominated user repeats from step 602 in response to the user choosing a multi-user mode.

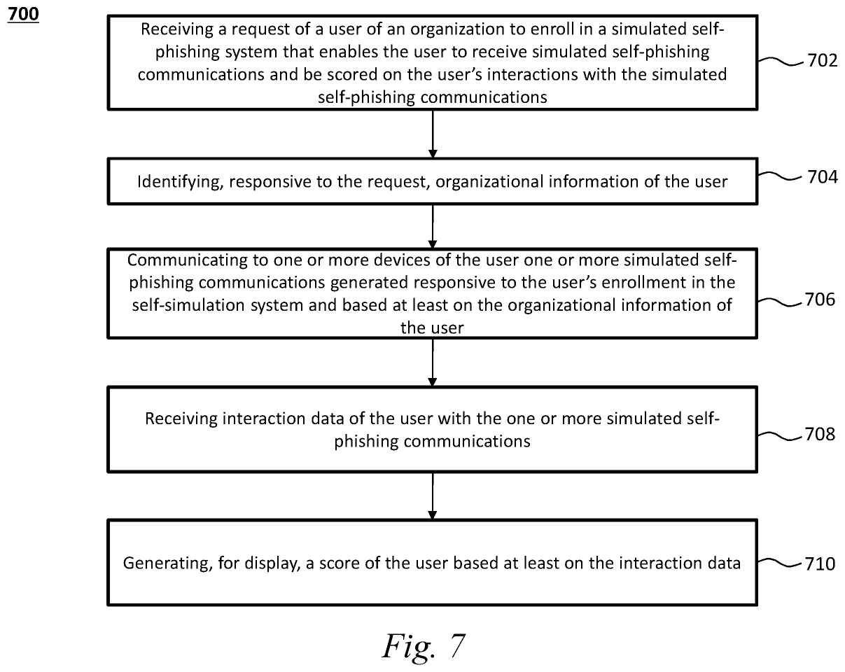

FIG. 7 illustrates a process flow depicting incentivizing engagement of a user, according to one embodiment.

In a brief overview of an implementation of flowchart 700, at step 702, a request of a user of an organization is received to enroll in a simulated self-phishing system that enables the user to receive simulated self-phishing communications and be scored on the user's interactions with the simulated self-phishing communications. At 704, responsive to the request, organizational information of the user is identified. At 706, one or more simulated self-phishing communications may be generated responsive to the user's enrollment in the simulated self-phishing system 240 and based at least on the organizational information of the user, one or more simulated self-phishing communications are communicated to one or more devices of the user. At 708, interaction data of the user with the one or more simulated self-phishing communications is received. At 710, a self-phish score of the user, based at least on the interaction data, is generated for display.

Step 702 includes receiving a request of a user of an organization to enroll in a simulated self-phishing system that enables the user to receive simulated self-phishing communications and received a self-phish score based on the user's interactions with the simulated self-phishing communications. In an example, simulated self-phishing system 240 may receive the request. According to an implementation, a user may select the option to be in one of a single user mode or a multi-user mode of the simulated self-phishing system. In an implementation, a user may select an option to have a test generated and sent to the user in the simulated self-phishing system. In an example, the user may have the option to provide personal information.

Step 704 includes identifying, responsive to the request, organizational information of the user. In an example, enrollment manager 242 may identify the organizational information. In an example, the enrollment manager 242 may identify the personal information and use it in combination with the organizational information.

Step 706 includes communicating to one or more devices of the user one or more simulated self-phishing communications generated responsive to the user's enrollment in the simulated self-phishing system 240 and based at least on the organizational information of the user. In an example, self-phish manager 242 may generate and communicate the one or more simulated self-phishing communications.

Step 708 includes receiving interaction data of the user with the one or more simulated self-phishing communications. According to an implementation, the interaction data is obtained from email client 220 or email client plug-in 222. According to an implementation, self-phish manager 244 generates a test to communicate to the user responsive to the interaction data. Step 710 includes generating for display a self-phish score of the user based at least on the interaction data.

The systems described above may provide multiple examples of any or each component and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by a server, a request of a user of an organization to enroll in a simulated self-phishing system that enables the user to receive simulated self-phishing communications and be scored on the user's interactions with the simulated self-phishing communications;
identifying, by the server responsive to the request, organizational information of the user;
communicating, by the server, to one or more devices of the user one or more simulated self-phishing communications generated responsive to the user's enrollment in the simulated self-phishing system and based at least on the organizational information of the user;
receiving, by the server, interaction data of the user with the one or more simulated self-phishing communications; and
generating, by the server for display, a score of the user based at least on the interaction data.

2. The method of claim 1, further comprising receiving, by the server responsive to the request to enroll, a selection of the user to be in one of a single user mode or a multi-user mode of the simulated self-phishing system.

3. The method of claim 2, wherein the multi-user mode of the simulated self-phishing system is configured to display the score of the user with scores of other users in an enumerated list of scores.

4. The method of claim 2, further comprising receiving, by the server responsive to the selection of the user to be in the single user mode of the simulated self-phishing system, one or more parameters to adjust one of content or delivery of the one or more simulated self-phishing communications.

5. The method of claim 4, wherein the one or more parameters comprises identification of one or more of the following: a range of time in which to receive the one or more simulated self-phishing communications, a number of how many simulated self-phishing communications to receive, and a time window in which a first simulated self-phishing communication is to be sent.

6. The method of claim 4, wherein the one or more parameters comprise identification of one or more of the following: a type of simulated self-phishing communication, a difficulty level of the simulated self-phishing communication and a mode of communication of the simulated self-phishing communication.

7. The method of claim 2, further comprising generating, by the server, the one or more simulated self-phishing communications based at least on the selection of the user to be in one of the single user mode or the multi-user mode of the simulated self-phishing system.

8. The method of claim 1, further comprising receiving, by the server, personal information of the user comprising one or more of the following: a personal email address, a personal phone number, information of one or more social media accounts, a hometown of the user, a birthdate, a gender, a club, an interest or an affiliation.

9. The method of claim 7, further comprising generating, by the server, the one or more simulated self-phishing communications using the personal information of the user.

10. The method of claim 7, further comprising adjusting, by the server responsive to receiving the personal information, the score of the user.

11. The method of claim 1, further comprising generating, by the server responsive to the interaction data, a test to communicate to the user.

12. The method of claim 10, further comprising adjusting, by the server, responsive to receiving results of the test, the score of the user.

13. A system comprising:
one or more processors, coupled to memory and configured to:
receive a request of a user of an organization to enroll in a simulated self-phishing system that enables the user to receive simulated self-phishing communications;
identify, responsive to the request, organizational information of the user;
communicate to one or more devices of the user one or more simulated self-phishing communications generated responsive to the user's enrollment in the simulated self-phishing system and based at least on the organizational information of the user;
receive interaction data of the user with the one or more simulated self-phishing communications; and
generate for display on a display device a score of the user based at least on the interaction data.

14. The system of claim 13, wherein the one or more processors are further configured to receive, responsive to the request to enroll, a selection of the user to be in one of a single user mode or a multi-user mode of the simulated self-phishing system.

15. The system of claim 14, wherein the multi-user mode of the simulated self-phishing system is configured to display the score of the user with scores of other users in an enumerated list of scores.

16. The system of claim 14, wherein the one or more processors are further configured to receive responsive to the selection of the user to be in the single user mode of the simulated self-phishing system, one or more parameters to adjust one of content or delivery of the one or more simulated self-phishing communications.

17. The system of claim 16, wherein the one or more parameters comprises identification of one or more of the following: a range of time for which to receive the one or more simulated self-phishing communications, a number of how many simulated self-phishing communications to receive, and a time window in which a first simulated self-phishing communication is to be sent.

18. The system of claim 16, wherein the one or more parameters comprises identification of one or more of the following: a type of simulated self-phishing communication, a difficulty level of the simulated self-phishing communication and a mode of communication of the simulated self-phishing communication.

19. The system of claim 13, wherein the one or more processors are further configured to generate the one or more simulated self-phishing communications based at least on the selection of the user to be in one of the single user mode or the multi-user mode of the simulated self-phishing system.

20. The system of claim 13, wherein the one or more processors are further configured to receive personal information of the user comprising one or more of the following: a personal email address, a personal phone number, information of one or more social media accounts, a hometown of the user, a birthdate, a gender, a club, an interest or an affiliation.

21. The system of claim 20, wherein the one or more processors are further configured to generate the one or more simulated self-phishing communications using the personal information of the user.

22. The system of claim 20, wherein the one or more processors are further configured to adjust, responsive to receiving the personal information, the score of the user.

23. The system of claim 13, wherein the one or more processors are further configured to generate, responsive to the interaction data, a test to communicate to the user.

24. The system of claim 23, wherein the one or more processors are further configured to adjusting, responsive to receiving results of the test, the score of the user.
